(19) United States
(12) Patent Application Publication
(10) Pub. No.: US 2010/0306705 A1
(43) Pub. Date: Dec. 2, 2010

(54) LOCKSCREEN DISPLAY

(75) Inventor: Fredrik Nilsson, Svedala (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/472,570

(22) Filed: May 27, 2009

(51) Int. Cl. G06F 3/048

(52) U.S. Cl. 715/835; 345/173; 715/863

(57) ABSTRACT

A method may include placing a device in a lockscreen mode and outputting information associated with a program to a touch screen display while the device is in the lockscreen mode. The method may also include allowing a user to interact with the program via the touch screen display while the device is in the lockscreen mode.

### TECHNICAL FIELD OF THE INVENTION

The invention relates generally to displays and, more particularly, to displaying information in a lockscreen mode.

### DESCRIPTION OF RELATED ART

Computer, communication and entertainment devices, such as personal computers (PCs), lap top computers, mobile terminals, personal digital assistants (PDAs), music playing devices, etc., often include a touch screen display that allow a user to interact with the device via the touch screen. In many situations, while a device is operating, the user may place the touch screen into a “lockscreen” mode in which interaction with the touch screen is essentially locked or disabled. For example, the touch screen may be configured to ignore any inputs while in the lockscreen mode. This may enable the user to avoid inadvertently providing an input while, for example, the device is in the user's pocket.

### SUMMARY

According to one aspect, a device is provided. The device includes a memory configured to store a plurality of applications and a touch screen display configured to operate in a locked mode. The device also includes user interface logic configured to receive a selection from a user, the selection identifying a first one of a plurality of applications, the first application being associated with the locked mode. The device further includes control logic configured to allow a user to interact with the first application via the touch screen display while the touch screen display is in the locked mode and prohibit interaction with other ones of the plurality of applications via the touch screen display while the touch screen display is in the locked mode.

Additionally, the control logic may be further configured to display information associated with the first application on the touch screen display while the touch screen display is in the locked mode.

Additionally, the first application may comprise a notes application, where the notes application comprises logic configured to output messages or notes to the touch screen display while the touch screen display is in the locked mode, and allow a user to interact with the messages or notes while the touch screen display is in the locked mode.

Additionally, the notes application may be further configured to receive input from the user via a finger or stylus contacting the touch screen display, store a first note based on the received input, and output the first note to the touch screen display when the touch screen display is in the locked mode.

Additionally, the notes application may be further configured to receive a gesture-based input from the user via the touch screen display, the gesture-based input corresponding to a delete command, and delete the first note in response to the received gesture-based input.

Additionally, when receiving input, the notes application may be configured to receive an input from the user via the touch screen display, the input corresponding to a message complete command, and store the message in response to the received input.

Additionally, the input corresponding to the message complete command may comprise at least one of an input encircling text information input by the user or an input corresponding to a period or tap on the touch screen display.

Additionally, the user interface logic may be further configured to receive input from the user identifying a second application, and display information associated with the second application on the touch screen display while the touch screen display is in the locked mode.

Additionally, the control logic may be further configured to allow the user to interact with the second application while the touch screen display is in the locked mode in response to the input identifying the second application, and not allow the user to interact with the first application while the touch screen display is in the locked mode in response to the input identifying the second application.

Additionally, when prohibiting interaction, the control logic may be configured to prohibit interaction with all of the plurality of applications other than the first application while the touch screen display is in the locked mode, receive an input to unlock the touch screen display, and allow the user to interact with the all of the plurality of applications via at least one of the touch screen display, control buttons or a keypad after reception of the input to unlock the touch screen display.

Additionally, the user interface logic may comprise a graphical user interface (GUI) configured to allow the user to select information associated with the first application that is to be provided on the touch screen display while the touch screen display is in the locked mode, and allow the user to select functionality associated with the information provided on the touch screen display that is to be enabled while the touch screen display is in the locked mode.

Additionally, the user interface logic may comprise a graphical user interface (GUI) configured to receive a gesture-based input from the user, the gesture-based input enclosing or identifying information displayed on the touch screen display, and output the enclosed or identified information to the touch screen display while the touch screen display is in the locked mode.

Additionally, the device may comprise a mobile terminal.

According to another aspect, a method is provided. The method comprises placing a device in a lockscreen mode and outputting information associated with a notes program to a touch screen display while the device is in the lockscreen mode. The method also comprises allowing a user to interact with the notes program via the touch screen display while the device is in the lockscreen mode and prohibiting interaction with other applications via the touch screen display while the device is in the lockscreen mode.

Additionally, the method may comprise providing a user interface, the user interface allowing the user to select a program to display information on the touch screen display while the device is in the lockscreen mode and receiving a selection via the user interface, the selection identifying the notes program. The outputting information may comprise displaying messages or notes associated with the notes program to the touch screen display.

Additionally, the method may further comprise identifying information to be provided on the touch screen display while the device is in the lockscreen mode based on a gesture provided by the user.

Additionally, the gesture may comprise an input enclosing information provided on the touch screen display. The method may further comprise outputting at least some of the enclosed information to the touch screen display while the device is in the lockscreen mode.

According to a further aspect, a computer-readable medium having stored thereon sequences of instructions is provided. The instructions, when executed by at least one processor, cause the at least one processor to place a device in a lockscreen mode, receive information from a user identifying a first program associated with the lockscreen mode, and output information associated with the first program to a touch screen display while the device is in the lockscreen mode.

Additionally, the computer-readable medium may further include instructions for causing the at least one processor to allow a user to interact with the first program via the touch screen display while the device is in the lockscreen mode, and prohibit interaction with other applications via the touch screen display while the device is in the lockscreen mode.

Additionally, the computer-readable medium may further include instructions for causing the at least one processor to identify information associated with the first program that is to be output to the touch screen display while the device is in the lockscreen mode based on a gesture provided by the user.

### BRIEF DESCRIPTION OF THE DRAWINGS

Reference is made to the attached drawings, wherein elements having the same reference number designation may represent like elements throughout.

FIG. 1 is a diagram of an exemplary device in which methods and systems described herein may be implemented;

FIG. 2 is a functional block diagram of exemplary components implemented in the device of FIG. 1;

FIG. 3 is a block diagram of components implemented in the device of FIG. 2 according to an exemplary implementation;

FIG. 4 is a flow diagram illustrating exemplary processing associated with generating notes for display by the user device of FIG. 1;

FIG. 5 is a diagram illustrating the creation of a note in accordance with the processing of FIG. 4;

FIG. 6 is a flow diagram illustrating exemplary processing associated with displaying information while the device of FIG. 1 is in a lockscreen mode; and

FIG. 7 is a diagram illustrating the display of information in accordance with the processing of FIG. 6.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

### Exemplary System

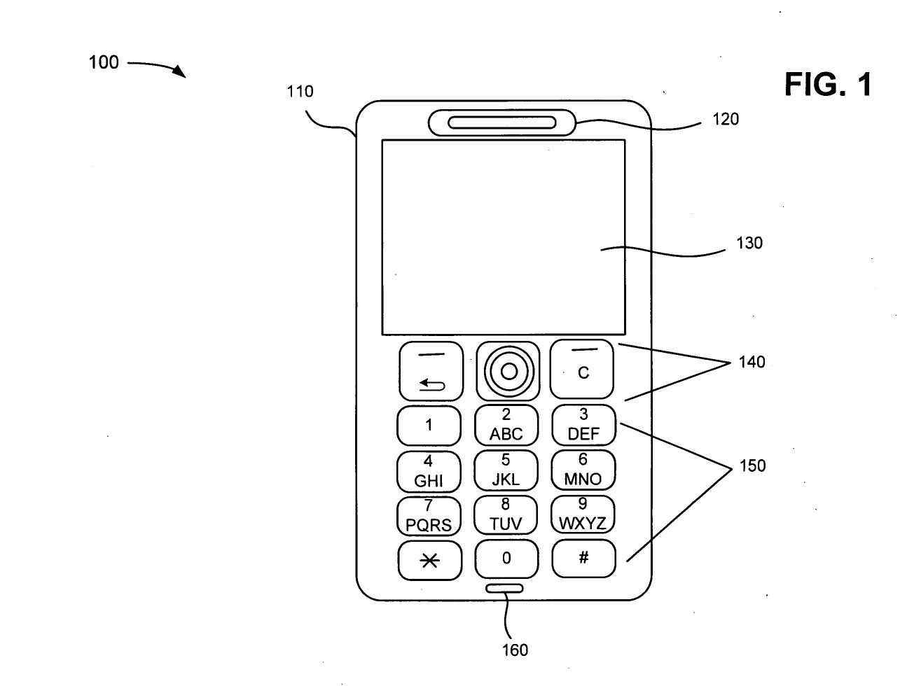

FIG. 1 is a diagram of an exemplary user device 100 in which methods and systems described herein may be implemented. In an exemplary implementation, user device 100 may be a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. It should also be understood that systems and methods described herein may also be implemented in other devices that display information of interest and allow users to interact with the displayed information with or without including various other communication functionality. For example, user device 100 may include a personal computer (PC), a laptop computer, a personal digital assistant (PDA), a media playing device (e.g., an MPEG audio layer 3 (MP3) player, a video game playing device), a global positioning system (GPS) device, etc., that may not include various communication functionality for communicating with other devices.

Referring to FIG. 1, user device 100 may include a housing 110, a speaker 120, a display 130, control buttons 140, a keypad 150, and a microphone 160. Housing 110 may protect the components of user device 100 from outside elements. Speaker 120 may provide audible information to a user of user device 100.

Display 130 may provide visual information to the user. For example, display 130 may provide information regarding incoming or outgoing telephone calls, electronic mail (e-mail), instant messages, short message service (SMS) messages, etc. Display 130 may also display information regarding various applications, such as a messaging or notes application stored in user device 100, a phone book/contact list stored in user device 100, the current time, video games being played by a user, downloaded content (e.g., news or other information), songs being played by the user, etc. In an exemplary implementation, display 130 may be a touch screen display device that allows a user to enter commands and/or information via a finger, a stylus, a mouse, a pointing device, or some other device. For example, display 130 may be a resistive touch screen, a capacitive touch screen, an optical touch screen, an infrared touch screen, a surface acoustic wave touch screen, or any other type of touch screen device that registers an input based on a contact with the screen/display 130.

Control buttons 140 may permit the user to interact with user device 100 to cause user device 100 to perform one or more operations, such as place a telephone call, play various media, etc. In an exemplary implementation, control buttons 140 may include one or more buttons that controls various applications associated with display 130. For example, one or more of control buttons 140 may be used to initiate execution of an application program that permits a user to configure options associated with displaying information while display 130 is in a lockscreen mode, as described in detail below.

Keypad 150 may include a standard telephone keypad. Microphone 160 may receive audible information from the user for activating applications or routines stored within user device 100.

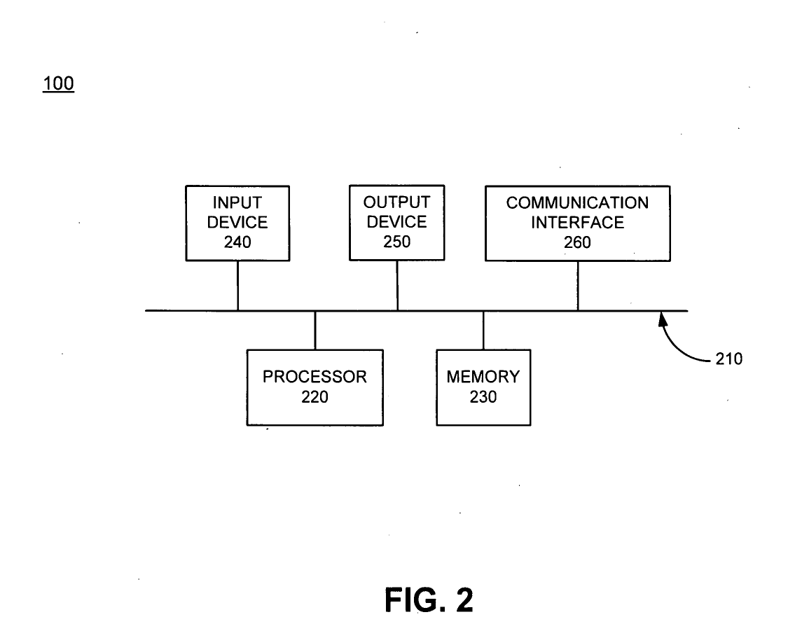

FIG. 2 is a diagram illustrating components of user device 100 according to an exemplary implementation. User device 100 may include bus 210, processor 220, memory 230, input device 240, output device 250 and communication interface 260. Bus 210 permits communication among the components of user device 100. One skilled in the art would recognize that user device 100 may be configured in a number of other ways and may include other or different elements. For example, user device 100 may include one or more modulators, demodulators, encoders, decoders, etc., for processing data.

Processor 220 may include a processor, microprocessor, an application specific integrated circuit (ASIC), field programmable gate array (FPGA) or other processing logic. Processor 220 may execute software instructions/programs or data structures to control operation of user device 100.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220. A computer-readable medium may include one or more memory devices.

Input device 240 may include mechanisms that permit an operator to input information to user device 100, such as microphone 160, keypad 150, control buttons 140, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, voice recognition and/or biometric mechanisms, etc. In an exemplary implementation, display 130 may be a touch screen display that acts as an input device.

Output device 250 may include one or more mechanisms that output information to the user, including a display, such as display 130, a printer, one or more speakers, such as speaker 120, etc. As described above, in an exemplary implementation, display 130 may be a touch screen display. In such an implementation, display 130 may function as both an input device and an output device.

Communication interface 260 may include any transceiver-like mechanism that enables user device 100 to communicate with other devices and/or systems. For example, communication interface 260 may include a modem or an Ethernet interface to a LAN. Communication interface 260 may also include mechanisms for communicating via a network, such as a wireless network. For example, communication interface 260 may include one or more radio frequency (RF) transmitters, receivers and/or transceivers and one or more antennas for transmitting and receiving RF data via a network.

User device 100 may provide a platform for a user to send and receive communications (e.g., telephone calls, electronic mail messages, text messages, multi-media messages, short message service (SMS) messages, etc.), play music, browse the Internet, or perform various other functions. User device 100, as described in detail below, may also perform processing associated with displaying information via display 130 while in a lockscreen mode. User device 100 may perform these operations in response to processor 220 executing sequences of instructions contained in a computer-readable medium, such as memory 230. Such instructions may be read into memory 230 from another computer-readable medium via, for example, and communication interface 260. In alternative embodiments, hard-wired circuitry may be used in place of or in combination with software instructions to implement processes consistent with the invention. Thus, implementations described herein are not limited to any specific combination of hardware circuitry and software.

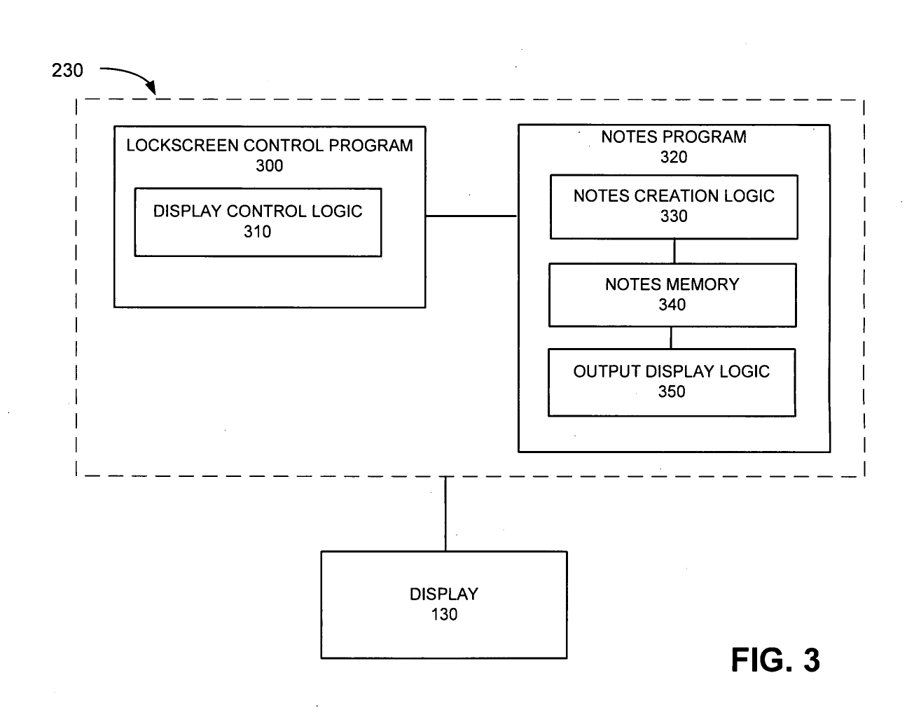

FIG. 3 is an exemplary block diagram of components implemented in user device 100 of FIG. 2. In an exemplary implementation, all or some of the components illustrated in FIG. 3 may be stored in memory 230. For example, referring to FIG. 3, memory 230 may include lockscreen control program 300 and notes program 320.

Lock screen control program 300 may include a software program executed by processor 220 that allows a user to lock display 130 from receiving most inputs. In an exemplary implementation, lockscreen control program 300 may include display control logic 310.

Display control logic 310 may include a graphical user interface (GUI) that allows a user to place display 130 into a lockscreen mode. Alternatively, display control logic 310 may allow a user to use display 130, control buttons 140 and/or keypad 150 to place display 130 in a lockscreen mode. The term “lockscreen mode/state” or “locked mode/state” should be construed herein to include a mode or state in which user device 100 is configured to ignore or prohibit at least some inputs from one or more of display 130, control buttons 140 and keypad 150. For example, in one implementation, while in the lockscreen mode, user device 100 may be configured to ignore inputs from display 130, control buttons 140 and keypad 150. In another implementation, while display 130 in the lockscreen mode, user device 100 may be configured to ignore inputs from display 130 and permit inputs from control buttons 140 and/or keypad 150. In each case, lockscreen control program 300 may prevent inputs entered via one or more of display 130, control buttons 140 and keypad 150 from being processed and performing any functions.

In an exemplary implementations, the GUI provided by display control logic 310 may allow a user to select a particular program or application which will provide items for display while display 130 is in the locked state. For example, in some devices, while user device 100/display 130 is in the locked state, the device may display a black screen or a screen displaying only the time or other system related information (e.g., battery life). In an exemplary implementation described in detail below, display control logic 310 may interact with various application programs to display information of interest while display 130 is in the lockscreen mode, instead of providing a static screen or a blank screen. In still further implementations, the GUI provided by display control logic 310 may also allow a user to customize various display-related parameters, such as the locations for displaying items of interest, brightness parameters for displaying items of interest, size parameters associated with displaying items of interest, etc., associated with information provided on display 130 while display 130 is in a lockscreen mode, as described in detail below.

Notes program 320 may include a software program executed by processor 220 that allows a user to create short notes or messages that may be output to display 130. In an exemplary implementation, notes program 320 may include notes creation logic 330, notes memory 340 and output display logic 350.

Notes creation logic 330 may include logic for allowing a user to create, modify and delete notes or messages that may be output to display 130. In an exemplary implementation, notes creation logic 330 may allow a user to create notes via interaction with a finger, stylus, mouse or pointing device on display 130. For example, a user may write a note with his/her finger on the surface of display 130, which may be a touch screen display. In some implementations, the user may indicate that the note is complete and is to be used for a lockscreen display by making various gestures on the surface of display 130, such as encircling the note, drawing a period after the note, etc. Notes creation logic 330 may then store the note in notes memory 340 and/or display the note on display 130, as described in detail below.

Notes memory 340 may include one or more memories used to store notes created by a user. As described above, notes from notes memory 340 may be output to display 130.

Output display logic 350 may include logic that controls information to be output from notes program 320 to display 130. For example, output display logic 350 may interact with lockscreen control program 300 and display 130 to output messages or notes on display 130 while display 130 is in a lockscreen mode, as described in detail below.

The programs and logic blocks illustrated in FIG. 3 are provided for simplicity. It should be understood that other configurations may be possible. It should also be understood that functions described as being performed by one program or logic block within a program may alternatively be performed by another program and/or another logic block. In addition, functions described as being performed by multiple programs or logic blocks may alternatively be performed by a single program or logic block/device.

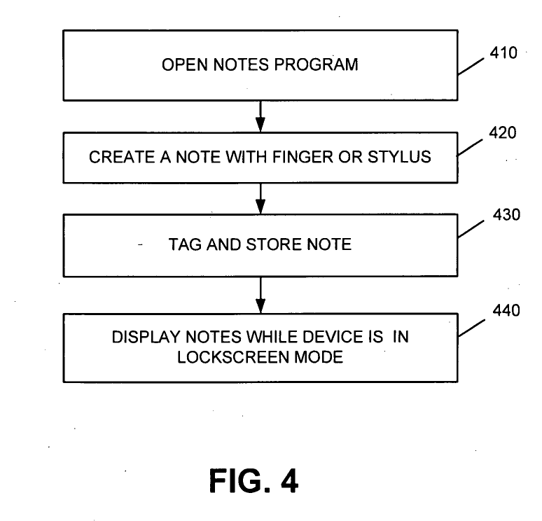

FIG. 4 illustrates exemplary processing associated with using display 130 to create notes that may be output to display 130. Processing may begin with a user of user device 100 accessing notes program 320 (act 410). For example, a user of user device 100 may open or launch notes program 320 using one or more of control buttons 140 and/or an applications menu provided on display 130. Notes program 320, as described above, may include notes creation logic 330 that allows a user to create notes using, for example, the user's finger or a stylus.

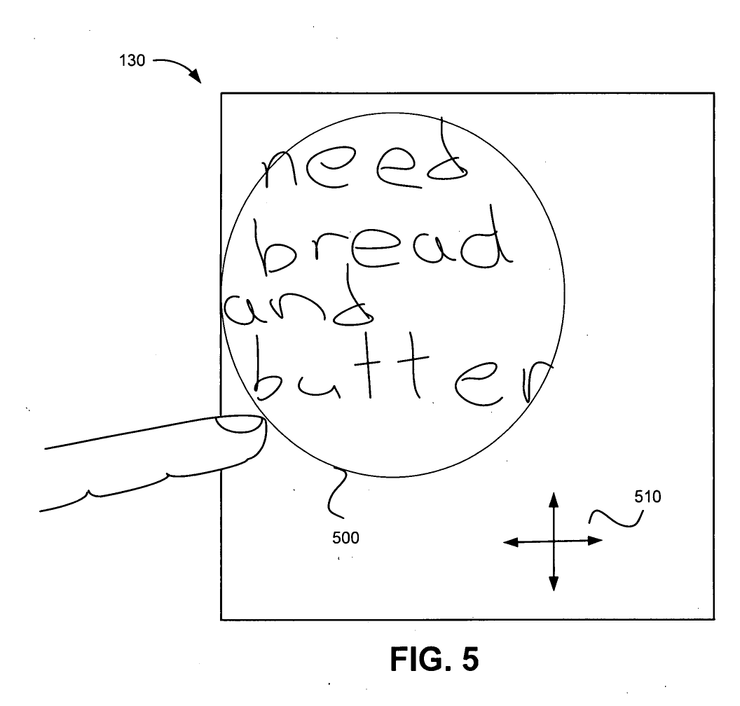

For example, assume that the user has selected a “writing mode/create notes mode” associated with notes program 320. In this case, notes creation logic 330 may be configured to receive input entered by the user via display 130 to create a note or message. For example, the user may write a note with his/her finger, stylus, mouse, pointing device, etc., on the surface of display 130 (act 420). For example, assume that the user writes a note with his/her finger on the surface of display 130, such as “need bread and butter,” as illustrated in FIG. 5.

After the user has completed the note, the user may tag/flag and/or store the note (act 430). For example, in one implementation, the user may draw a ring or some other shape around the entered text (i.e., “need bread and butter” in this example), as illustrated by ring 500 in FIG. 5 to indicate that the note is completed and should be tagged or flagged for display while user device 100 is in the lockscreen mode. Notes creation logic 330 may then store the note in notes memory 340. In alternative implementations, the user may perform another gesture or act to indicate that the note is completed and should be tagged for display while user device 100 is in the lockscreen mode. For example, the user may make a dot or period with his/her finger on the surface of display 130, make a check mark on the surface of display, or perform some other act to indicate that the note is complete and should be tagged for storage and eventual output to display 130. In still other instances in which user device 100 is configured to recognize various images/gestures, the user may provide a gesture over the surface of display 130 to indicate that the message is completed and should be tagged for eventual output to display 130. For example, the user may provide a “thumbs up” gesture that may be recognized by image recognition logic in user device 100 to indicate that the message is to be output to display 130 while user device 100 is in the lockscreen mode. In each case, the user may provide an indication that the message is completed. In still other instances, user device 100 may assume that a message is completed after the user has stopped providing input via touch screen display 130 for a predetermined period of time. For example, if the user has entered “need bread and butter,” as illustrated in FIG. 5, user device 100 may wait a predetermined period of time (e.g., 10 seconds, 30 seconds, etc.) and store the note.

In an exemplary implementation, notes creation logic 330 may automatically scale the size of the note that will be displayed based on the particular message. For example, notes creation logic 330 may size a short message, such as “call home,” to be small as compared to a longer note, such as “meeting to discuss new project in conference room on 11th floor at 10:00 AM.” In other instances, notes creation logic 330 may allow the user to scale the physical size of the message based on the user's particular requirements. For example, in some instances, notes creation logic 330 may include a sizing icon to allow a user to modify the size of the message. For example, in one implementation, the user may use icon 510 illustrated in FIG. 5 to increase or decrease the size of the note. That is, the user may use the up/down arrows in icon 510 to increase/decrease the size of the note that may be later displayed on display 130. In other instances, the user may drag his/her finger from the corner or sides of the note to increase or decrease the size of the note. In this manner, a user may provide large notes for instances where the notes convey more important information to the user.

In each case, after the note is completed, output display logic 350 may be configured to retrieve notes stored in notes memory 340 for output on display 130 when display 130 in a lockscreen mode (act 440). For example, as discussed above, in an exemplary implementation, notes program 320 may interact with lockscreen program 300 to display various notes on display 130 while display 130 is in a lockscreen mode, as described in detail below.

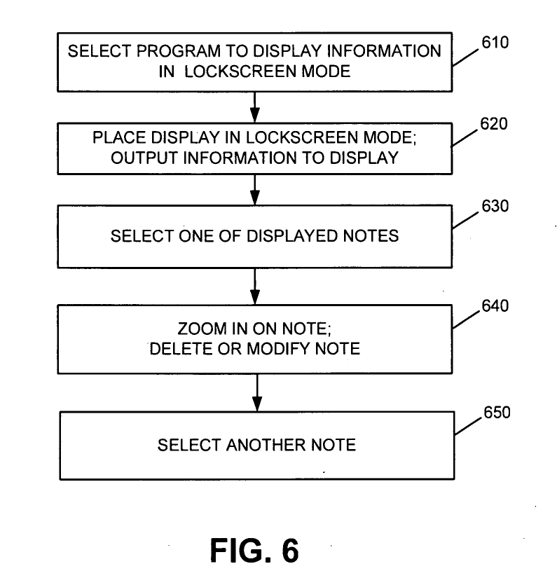

FIG. 6 illustrates exemplary processing associated with providing information on display 130. Processing may begin with the user of user device 100 interacting with the GUI associated with display control logic 310 to select an application that will provide information on display 130 while display 130 is in the lockscreen mode (act 610). For example, assume that the user has selected notes program 320 as being the program that will output information to display 130 while display 130 is in the lockscreen mode.

Further assume that the user of user device 100 places display 130 in the lockscreen mode (act 620). For example, assume that the user of user device 100 has provided input that prevents display 130, control keys 140 and keypad 150 from accepting/processing at least some inputs. Alternatively, lockscreen control program 300 may be configured to place display 130 in lockscreen mode if no input has been received by user device 100 within a predetermined amount of time.

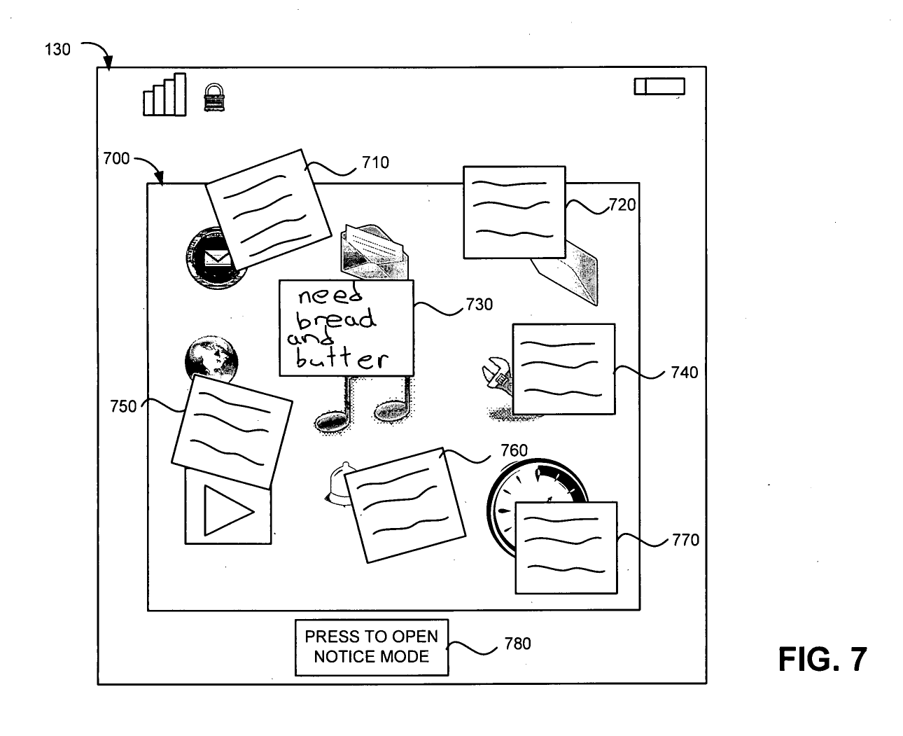

Output display logic 350 and/or display control logic 310 may then output information to display 130 (act 620). For example, display control logic 310 may send a message to output display logic 350 instructing output display logic 350 to output various notes stored in notes memory 340 to display 130, as illustrated in FIG. 7. Referring to FIG. 7, display 130 includes seven notes, labeled 710-770, provided on display 130, including note 730 which corresponds to the note illustrated in FIG. 5. It should be understood that other numbers of notes may be provided on display 130. In addition, in some implementations, the user may pan or scroll display 130 to display additional notes that may not fit on a single display 130. For example, the user drag or flick his/her finger or a stylus in a particular direction to display additional notes on display 130.

In one implementation, notes 710-770 may correspond to notes that were tagged or flagged by the user for display while display 130 is in the lockscreen mode. For example, the user may tag various notes as described above (e.g., enclosing the note with a circle or other shape) with respect to FIG. 4. In other implementations, output display logic 350 may retrieve a predetermined number of the most recently created notes stored in notes memory 340 and output these notes to display 130.

Display 130 may also include button 780 labeled “press to open notice mode.” In the exemplary implementation illustrated in FIG. 7, notes 710-770 may be provided over a desktop/standby screen 700 that includes various icons associated with different applications on user device 100 (e.g., an email program, a text messaging application, a web browsing application, music playing application, etc.). In other implementations, notes 710-770 may be provided over a dark screen to conserve battery life of user device 100.

In either case, assume that the user would like to select one of notes 710-770 for viewing (act 630). In an exemplary implementation, the user may press button 780 to begin interacting with notes 710-770. In other implementations, the user may simply select one of notes 710-770 by touching the note and without pressing a button, such as button 780. In each case, the user may interact with notes 710-770 without unlocking other functionality associated with user device 100. That is, the user may interact with notes 710-770 without unlocking the features associated with other programs, such as the programs represented on the desktop/standby screen 700 illustrated in FIG. 7.

Assume that the user has selected note 730 by pressing button 780 followed by pressing on a portion of note 730. The user may then zoom in on the note (act 640). For example, the user may use his/her finger to drag a corner of note 730 in an outward direction to enlarge the size of note 730 or tap on any portion of note 730 to enlarge the size of note 730. In an alternative implementation, once the user has selected the note (i.e., note 730 in this example), note 730 may automatically be enlarged by a predetermined amount to make it easier for the user to read the message.

The user may also perform other actions with respect to the selected note. For example, the user move the note to another area of display 130 by dragging the particular note with his/her finger to another portion of display 130. In this manner, display 130 may act as a notice board for the user with each of notes 710-770 essentially acting as “sticky” notes that may be moved around in any user desired configuration.

While in notice mode, the user may also delete or modify various notes (640). For example, in one implementation, the user may input a gesture on the surface of display 130 to instruct notes program 320 to delete the note. As one example, the user may draw an “X” with his/her finger on the surface of display 130 and/or over the displayed note. Notes creation logic 330 may be configured to recognize this gesture as a deletion command and may delete the note. In other implementations, the user may instruct notes program 320 to delete the note using other actions/gestures, such as drawing a line through the displayed note, performing a “flicking” gesture with his/her finger on the surface of display 130, etc.

The user may also decide to modify the note. For example, after selecting a note, the user may begin writing with his/her finger on the surface of display 130 to modify the note. The modified note may then replace the original note. In some instances, notes creation logic 330 may be configured to identify an erase command to allow the user to more easily modify the note. For example, a back and forth motion by the user's finger over a portion of a selected note may be used to erase a portion of the note.

Assume that after viewing, modifying and/or deleting a note, the user would like to view another note. The user may select another note by tapping on any portion of that note (act 650). For example, the user may select note 720 by tapping on a portion of note 720. The user may then be able to read, modify and/or delete note 720 as described above.

As described above, the user may interact with information stored on display 130 without unlocking display 130. That is, features associated with the icons displayed on desktop screen 700 may be disabled. In addition, features associated with control keys 140 and keypad 150 may also be disabled. In essence, the information provided on display 130 may form a layered user interface, where the lower layer associated with, for example, a user desktop screen 700 may be locked. However, features associated with the information displayed over the desktop screen 700 (e.g., notes 710-770 in this example) may be “unlocked” for interaction with the user.

In other instances, all of the information provided on display 130 may be configured in a locked mode and the user may simply view the information. For example, in some implementations, notes 710-770 may be function as sticky notes that may simply be viewed when display 130 is in the lockscreen mode. In such implementations, however, display 130 may allow no further interaction with notes 710-770 without unlocking display 130. In this situation, display 130 may function as a message board while display 130 is in the lockscreen mode. In such implementations, the user may perform a predetermined action to unlock display 130 to allow interaction with the displayed notes, as described above. For example, lockscreen control program 300 may be configured to identify a sliding motion across the lower portion of display 130 as corresponding to a command to unlock the lockscreen mode. In other instances, lockscreen control program 300 may be configured to accept any number of “unlock” actions that correspond to an unlock command to unlock various functionality associated with items on display 130. In each case, lockscreen control program 300 may interact with other programs on user device 100 to provide information of interest to a user while user device 100 is in the lockscreen mode.

For example, as described above, the user may select notes program 320 as the program that will provide information on display 130 while display 130 is in the locked mode. In other implementations, the user may select or change programs that will interact with lockscreen control program 300.

For example, the user may select a music playing application to be used while display 130 is in the locked mode. In this situation, various music related functions/icons, such as a play icon, a pause icon, a fast forward icon, a skip to next song icon, etc., may be provided on display 130 while display 130 is in the locked mode. The user may then interact with these music-related icons while display 130 is otherwise locked.

As another example, the user may select a game playing application that allows the user to interact with that game while display 130 is in the locked mode, but with no other applications on user device 100. Again, the icons/function buttons provided on display 130 while user device 100 is in the lockscreen mode may be based on the particular program that is outputting information to display 130.

As still another example, the user may select a picture/photos application that will display items of interest while user device 100 is in the lockscreen mode. In this case, user device 100 may output various pictures stored in memory 230 to display 130. In such instances, the user may have selected particular pictures stored in memory 230 by using various gestures described above. For example, the user may have encircled various thumbnails of the pictures to identify particular pictures as ones that will be provided on display 130 while device 100 is in the lockscreen mode. In such implementations, the selected pictures may be provided on display 130 for a predetermined period and then replaced with another picture.

In each case, various items of interest and functionality associated with the display items of interest may be provided to the user while user device 100 is in the lockscreen mode. This provides the user with a more interesting lockscreen mode, as compared to a dark screen or a screen that allows for no interaction.

### CONCLUSION

Implementations described herein provide a lockscreen mode in which information that may be of interest is provided to a user. In addition, various functionality with respect to the displayed items may be provided to allow the user to more easily multi-task with respect to use of the user device. This may further enhances the user's overall experience with respect to use of the user device.

The foregoing description of the embodiments described herein provides illustration and description, but is not intended to be exhaustive or to limit the invention to the precise form disclosed. Modifications and variations are possible in light of the above teachings or may be acquired from the practice of the invention.

For example, aspects have been described above with respect to allowing a user to select a program in which information of interest may be provided on display 130 while user device 100 is in a lockscreen mode. In some implementations, the user interface may allow the user to select particular functionality with respect to the displayed items of interest. For example, in some instances, user device 100 may allow the user to interact with the items of interest with the full functionality associated with the program via which the items are displayed. In other instances, the user may select limited functionality with respect to the items of interest. For example, with respect to notes program 320, the user may select functionality that allows the user to view and move the displayed notes, but not delete any of the displayed notes.

In addition, in some implementations, the user may select brightness levels for the information that will be displayed on display 130 while user device is in the lockscreen mode. In such instances, the brightness level may be used as a visual indicator to indicate the programs that may be active (i.e., allow interaction) while display 130 is otherwise locked. For example, with respect to FIG. 7, icons on desktop screen 700 may be very light as compared to notes 710-770, indicating that notes 710-770 are active and the user may interact with notes 710-770, even though user device 100 is in the lockscreen mode.

Further, aspects described above refer to selecting a program that will display items of interest while user device 100 is in the lockscreen mode. In other instances, user device 100 may be pre-set to identify a default program that will display items of interest while user device 100 is in the lockscreen mode.

In addition, in the examples provided above, a single program interfaces with lockscreen control program 300 to display items on display 130 while user device 100 is in the lockscreen mode. In other implementations, the user may select multiple programs which will simultaneously provide information of interest on display 130 while user device 100 is in the lockscreen mode. In such implementations, display 130 may be divided into a number of portions which will provide items of interest for the number of different programs. In addition, in such implementations, each of the programs may allow the user to interact with the displayed items while user device 100 is in the lockscreen mode.

Further, while series of acts have been described with respect to FIGS. 4 and 6, the order of the acts may be varied in other implementations consistent with the invention. Moreover, non-dependent acts may be performed in parallel.

It will also be apparent to one of ordinary skill in the art that aspects of the invention, as described above, may be implemented in computer devices, cellular communication devices/systems, media playing devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an ASIC, an FPGA or other processing logic, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A device, comprising:
a memory configured to store a plurality of applications;
a touch screen display configured to:
operate in a locked mode;
user interface logic configured to:
receive a selection from a user, the selection identifying a first one of a plurality of applications, the first application being associated with the locked mode; and
control logic configured to:
allow a user to interact with the first application via the touch screen display while the touch screen display is in the locked mode, and
prohibit interaction with other ones of the plurality of applications via the touch screen display while the touch screen display is in the locked mode.

2. The device of claim 1, wherein the control logic is further configured to:
display information associated with the first application on the touch screen display while the touch screen display is in the locked mode.

3. The device of claim 1, wherein the first application comprises a notes application, the notes application comprising:
logic configured to:
output messages or notes to the touch screen display while the touch screen display is in the locked mode, and
allow a user to interact with the messages or notes while the touch screen display is in the locked mode.

4. The device of claim 3, wherein the notes application is further configured to:
receive input from the user via a finger or stylus contacting the touch screen display,
store a first note based on the received input, and
output the first note to the touch screen display when the touch screen display is in the locked mode.

5. The device of claim 4, wherein the notes application is further configured to:
receive a gesture-based input from the user via the touch screen display, the gesture-based input corresponding to a delete command, and
delete the first note in response to the received gesture-based input.

6. The device of claim 4, wherein when receiving input, the notes application is configured to:
receive an input from the user via the touch screen display, the input corresponding to a message complete command, and
store the message in response to the received input.

7. The device of claim 6, wherein the input corresponding to the message complete command comprises at least one of an input encircling text information input by the user or an input corresponding to a period or tap on the touch screen display.

8. The device of claim 1, wherein the user interface logic is further configured to:
receive input from the user identifying a second application, and
display information associated with the second application on the touch screen display while the touch screen display is in the locked mode.

9. The device of claim 8, wherein the control logic is further configured to:
allow the user to interact with the second application while the touch screen display is in the locked mode in response to the input identifying the second application, and
not allow the user to interact with the first application while the touch screen display is in the locked mode in response to the input identifying the second application.

10. The device of claim 1, wherein when prohibiting interaction, the control logic is configured to:
prohibit interaction with all of the plurality of applications other than the first application while the touch screen display is in the locked mode,
receive an input to unlock the touch screen display, and
allow the user to interact with the all of the plurality of applications via at least one of the touch screen display, control buttons or a keypad after reception of the input to unlock the touch screen display.

11. The device of claim 1, wherein the user interface logic comprises a graphical user interface (GUI) configured to:
allow the user to select information associated with the first application that is to be provided on the touch screen display while the touch screen display is in the locked mode, and
allow the user to select functionality associated with the information provided on the touch screen display that is to be enabled while the touch screen display is in the locked mode.

12. The device of claim 1, wherein the user interface logic comprises a graphical user interface (GUI) configured to:
receive a gesture-based input from the user, the gesture-based input enclosing or identifying information displayed on the touch screen display, and
output the enclosed or identified information to the touch screen display while the touch screen display is in the locked mode.

13. The device of claim 1, wherein the device comprises a mobile terminal.

14. A method comprising:
placing a device in a lockscreen mode;
outputting information associated with a notes program to a touch screen display while the device is in the lockscreen mode;
allowing a user to interact with the notes program via the touch screen display while the device is in the lockscreen mode; and
prohibiting interaction with other applications via the touch screen display while the device is in the lockscreen mode.

15. The method of claim 14, further comprising:
providing a user interface, the user interface allowing the user to select a program to display information on the touch screen display while the device is in the lockscreen mode; and
receiving a selection via the user interface, the selection identifying the notes program, wherein the outputting information comprises:
displaying messages or notes associated with the notes program to the touch screen display.

16. The method of claim 14, further comprising:
identifying information to be provided on the touch screen display while the device is in the lockscreen mode based on a gesture provided by the user.

17. The method of claim 16, wherein the gesture comprises an input enclosing information provided on the touch screen display, the method further comprising:
outputting at least some of the enclosed information to the touch screen display while the device is in the lockscreen mode.

18. A computer-readable medium having stored thereon sequences of instructions which, when executed by at least one processor, cause the at least one processor to:
place a device in a lockscreen mode;
receive information from a user identifying a first program associated with the lockscreen mode; and
output information associated with the first program to a touch screen display while the device is in the lockscreen mode.

19. The computer-readable medium of claim 18, further including instructions for causing the at least one processor to:
allow a user to interact with the first program via the touch screen display while the device is in the lockscreen mode; and
prohibit interaction with other applications via the touch screen display while the device is in the lockscreen mode.

20. The computer-readable medium of claim 18, further including instructions for causing the at least one processor to:
identify information associated with the first program that is to be output to the touch screen display while the device is in the lockscreen mode based on a gesture provided by the user.
